(19) United States
(12) Patent Application Publication
(10) Pub. No.: US 2013/0169503 A1
(43) Pub. Date: Jul. 4, 2013

(54) PARASITIC PATCH ANTENNA

(71) Applicant: Mohammad Fakharzadeh Jahromi, Toronto (CA)

(72) Inventor: Mohammad Fakharzadeh Jahromi, Toronto (CA)

(21) Appl. No.: 13/340,920

(22) Filed: Dec. 30, 2011

(51) Int. Cl. H01Q 19/02

(52) U.S. Cl. 343/833

(57) ABSTRACT

A microstrip antenna includes at least one parasitic patch, located beside a central patch. The parasitic patch is electrically disconnected from the central patch, yet coupled to it, inductively or otherwise, to aid in transferring energy to/from the central patch.

### FIELD OF THE INVENTION

The present invention relates generally to antennas, and more particularly to a micro-strip antenna having coupled patches, providing broad frequency response.

### BACKGROUND OF THE INVENTION

Radio receivers/transmitters require one or more antennas. Modern electronic devices, such as portable computing devices including laptops, tablet and cellular telephones, wireless network base stations, wireless network interfaces, and the like, all require inclusion of one more such antennas. As these devices have become smaller and more versatile, the size of these antennas has also needed to be reduced.

One common type of antenna is a “patch” or mircostrip antenna. Patch antennas are often used in electronic devices such as cellular handsets, because they have a low profile, and can be mounted or formed on flat surfaces. Typically, a patch antenna is formed as a flat sheet of conductive material (usually metal), mounted over a metal sheet acting as ground plane, and separated by a dielectric. The two metal sheets on either side of the dielectric together form a resonant piece of microstrip transmission line that acts as the antenna.

Reducing antenna size while providing adequate gain, over a desired frequency range and reception/transmission angles remains a challenge.

Accordingly, there remains a need for small antennas capable of being contained in small packages, and that provide a desired gain across a frequency range.

### SUMMARY OF THE INVENTION

Exemplary of an embodiment of the present invention, a microstrip antenna comprises at least one parasitic patch, located beside a central patch, the parasitic patch electrically disconnected from the central patch, but inductively coupled thereto aid in transferring energy to and from the central patch.

In accordance with an embodiment, an antenna includes a central patch dimensioned to transmit or receive a radio signal at a center frequency f_{c} having a corresponding wavelength λ, formed on a substrate; a feed line extending from said central patch; at least one parasitic patch, located beside the central patch; a ground plane formed on an opposite side of said substrate. The parasitic patch is electrically disconnected from the central patch, and located a lateral distance d≦λ/8 from the central patch.

In accordance with another aspect of the present invention, there is provided a method of operating an antenna to radiate an electromagnetic field. The method comprises: providing a central patch dimensioned to emit a radio signal at a center frequency f_{c} having a corresponding wavelength λ, formed on one side of a substrate having a ground plane formed on an opposite side thereof; providing at least one parasitic patch, located beside the central patch; driving the central patch by current from a transmitter and thereby inducing current to the parasitic patch that contributes constructively in radiating the electromagnetic field.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a perspective view of a conventional patch antenna;

FIG. 2 is a plan view of a parasitic patch antenna, exemplary of an embodiment of the present invention;

FIG. 3 is a cross-sectional view of FIG. 2, along lines

FIG. 4 is a graph illustrating the reflection coefficient an antenna in the form of the antenna of FIG. 2;

FIG. 5 is a receive radiation pattern of an antenna in the form of the antenna of FIG. 2; and

FIG. 6 is a transmit radiation pattern an antenna in the form of the antenna of FIG. 2;

FIGS. 7A-7E are plan views of alternate antennas exemplary of embodiments of the present invention.

### DETAILED DESCRIPTION

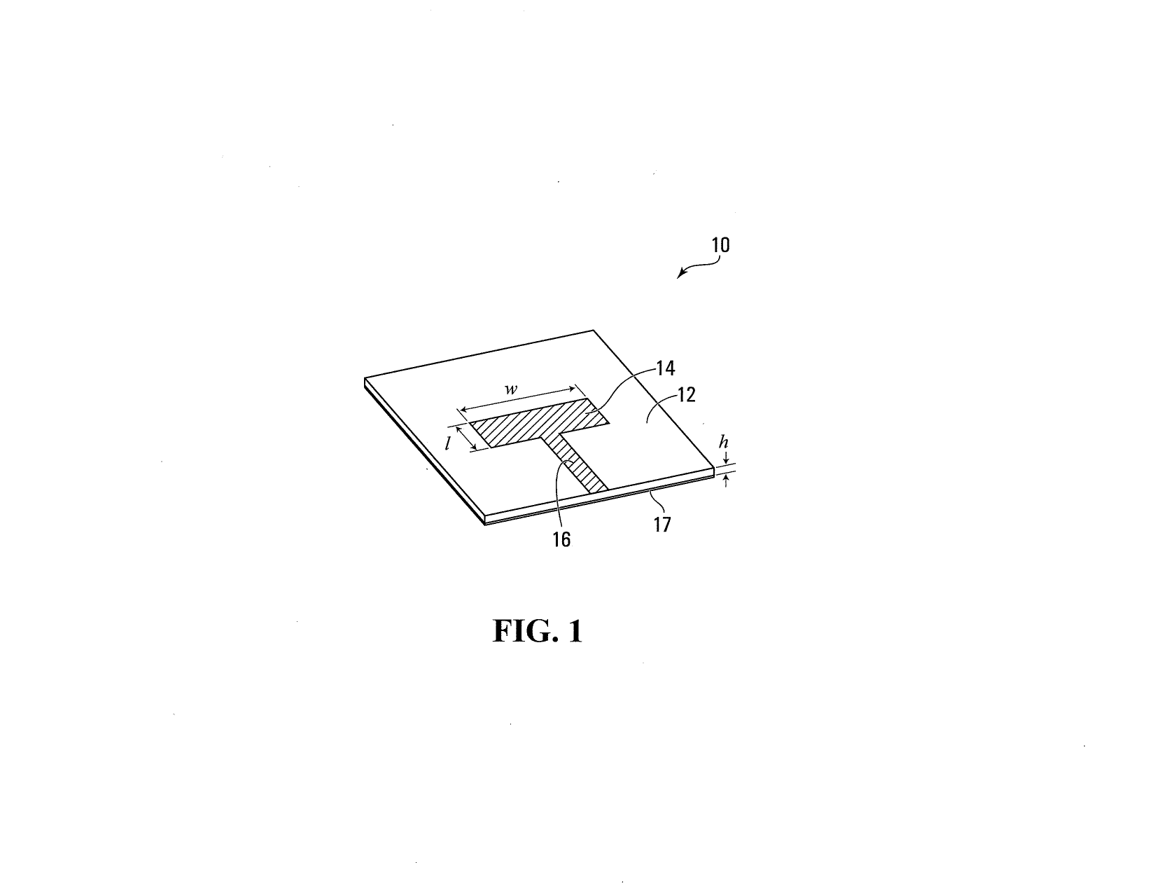

FIG. 1 is a perspective view of a conventional patch antenna 10. Antenna 10 includes a rectangular patch 14, formed of a conductive material formed on one side of substrate 12. A feed line 16 extends from patch 14. A conductive sheet 17 that covers some or all of the opposite side of substrate 12 forms a ground plane for antenna 10.

The gain and bandwidth of antenna 10 is controlled by the geometry of patch 14 (e.g. length and width), and physical characteristics of substrate 12 (e.g. height h, and dielectric constant, ∈ᵣ).

Similarly, the matching impedance of antenna 10 is controlled by the geometry of feed line 16 and physical characteristics of substrate 12.

As for example detailed in EE144/245 Patch Antenna Design, Spring 2007, H. Miranda, Stanford University, the contents of which are hereby incorporated, the length and width of patch 14, expressed as function of the desired reception/transmission (i.e. center) frequency of antenna 10, may be calculated as,

$$W = \frac{c}{2 {f}_{r}} {( \frac{{ɛ}_{r} + 1}{2} )}^{- 1 / 2} = λ \sqrt{\frac{1}{2 ( {ɛ}_{r} + 1 )}} \approx λ / 2$$

$$and$$

$$L = \frac{c}{2 {f}_{r} \sqrt{{ɛ}_{eff }}} - 2 Δ l$$

$$with$$

$${ɛ}_{eff} = \frac{{ɛ}_{r} + 1}{2} + \frac{{ɛ}_{r} - 1}{2} {( 1 + \frac{12 h}{W} )}^{- 1 / 2}$$

$$and$$

$$Δ l = 0.412 h ( \frac{{ɛ}_{eff} + 0.3}{{ɛ}_{eff} - 0.258} ) ( \frac{W / h + 0.264}{W / h + 0.8} )$$

where c is the speed of light, fᵣ is the center frequency of the antenna, ∈ᵣ is the relative permeability of the substrate 12, h is the height of substrate 12, and W is the width of the patch 14.

As will be appreciated, antenna 10 will radiate/absorb electro-magnetic waves in different planes with different efficiencies, in dependence on the geometry of antenna 10. It may, for example, be shown that the beam width for antenna 10 is about 65° and the gain is between about 7 and 9 dBi. As will be appreciated, gain is linked to overall geometry of the patch. With a simple rectangular patch as in antenna 10, geometric variations are limited.

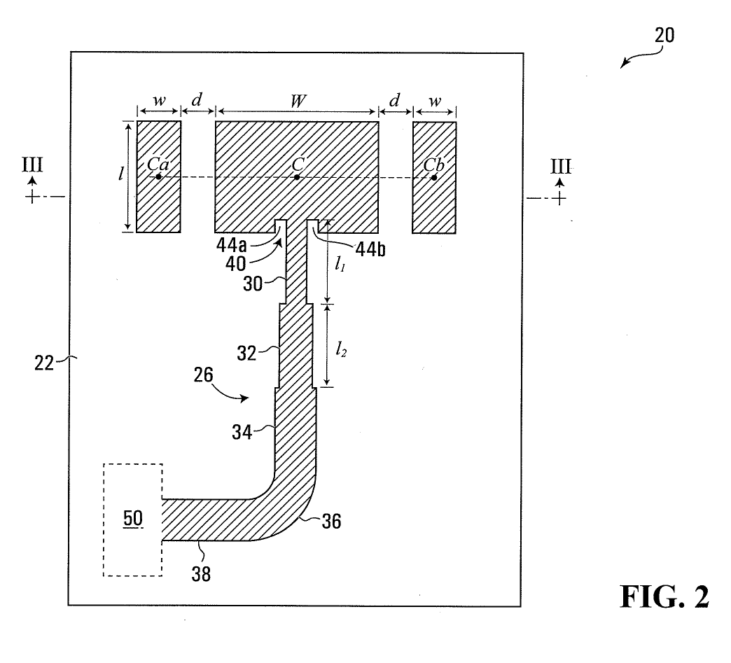

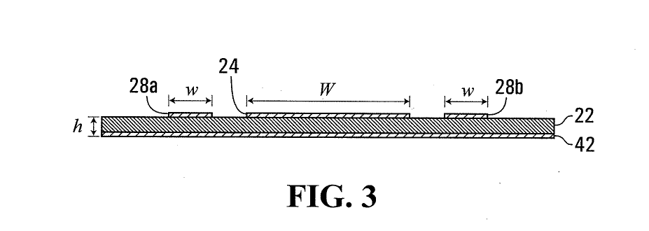

Exemplary of an embodiment of the present invention, the effective area of a patch antenna may be increased, by including one or more coupled (also referred to as parasitic) patches, as illustrated in FIGS. 2 and 3.

As illustrated, an exemplary antenna 20 includes central patch 24, interconnected with a feed 26. Coupled parasitic patches 28a and 28b are located laterally on either side of patch 24 formed on a substrate 22. The side of substrate 22 opposite patch 24 and patches 28a and 28b is conductively coated, to provide a ground plane 42.

In the depicted embodiment, antenna 20 central patch and parasitic patches 28a and 28b are generally rectangular. As illustrated, central patch 24 has a width W and a height L. Patches 28a and 28b are also each rectangular, with a width w, and height L, equal to the height of central patch 24. Patches 28a and 28b are aligned vertically, with vertical center (C) of patch 24 and are aligned with the vertical center (Cₐ, C_{b}) of each of patches 28a and 28b. As heights of patches 28a, 28b and 24 are equal, tops and bottoms of patches 28a, 28b and 24 are also aligned.

Patches 24 and 28a and 28b are electrically isolated (i.e. not conductively interconnected) from each other. Rather, patches 28a and 28b are coupled to central patch 24. For a transmitting antenna, patch 24 can thus be thought of the driven patch, driven by current from then transmitter. Current is induced to parasitic patches 28a, 28b and contributes constructively in radiating electromagnetic fields. For a receiving antenna, patch 24 may be considered a driving patch that drives the receiver. Again, current is induced to parasitic patches 28a, 28b and contributes constructively in receiving radiated electromagnetic fields. In order to be coupled to patch 24, patches 28a and 28b are in sufficiently proximity to central patch 24. In particular, patches 28a and 28b are spaced at a distance d from central patch 24. In the depicted embodiment, distance d is chosen to be less than λ/8. Without wishing to be bound a particular theory, it is believed that d is chosen to arrange patches 28a and 28b sufficiently close to central patch 24, so that electromagnetic radiation emitted by central patch 24 is coupled, inductively or otherwise, to patches 28a and 28b to assist in transmission of a signal from antenna 20; likewise electromagnetic radiation received by patches 28a and 28b is coupled to patch 24 to assist in reception of a signal at antenna 20.

The presence of parasitic patches 28a, 28b thus increases the effective area of antenna, without significantly affecting the center frequency of patch 24. In the depicted embodiment, the dimensions of patch 24 are chosen based on the desired center frequency f/ wavelength λ of antenna 20. The area of patch 24 is also chosen to be less than or equal to the area of the patch 14 of a conventional patch antenna (FIG. 1).

That is L*W≦

$$\frac{λ}{2} {( \frac{{ɛ}_{r} + 1}{2} )}^{- 1 / 2} * \{ \frac{λ}{2 \sqrt{{ɛ}_{eff }}} - 2 Δ l \}$$

$$with$$

$$Δ l = 0.412 h ( \frac{{ɛ}_{eff} + 0.3}{{ɛ}_{eff} - 0.258} ) ( \frac{W / h + 0.264}{W / h + 0.8} )$$

$$and$$

$${ɛ}_{eff} = \frac{{ɛ}_{r} + 1}{2} + \frac{{ɛ}_{r} - 1}{2} {( 1 + \frac{12 h}{W} )}^{- 1 / 2}$$

As before, ∈ᵣ denotes the relative permittivity of substrate 22, and h denotes its thickness.

From the foregoing, it may be recognized that L*W≦λ²/4. Specifically, L*W≦0.55*0.4λ²

Now, w is chosen to be about ¼ of W, e.g. w=0.14λ, and d≦λ/8.

For an antenna having a center frequency of about 60 GHz, on a substrate with ∈ᵣ˜3.5 and h˜125 μm, the size of the central patch 24 is L=1700×W=1240 μm²(0.55×0.4λ²). Each parasitic patch 28a, 28b is w=420×W=1240 μm² (0.14×0.4λ²). The space d between central patch 24 and patches 28a, 28b is 280 μm (0.09λ²).

As will become apparent, the presence of parasitic patches 28a, 28b couples energy at frequencies other than the center frequency f to central patch 24. So as not to unduly attenuate or filter signal at these additional frequencies, a feed line 26 that passes a broad frequency of electromagnetic signals is provided. To this end, central patch 24 further includes a slot 40 from which feed line 26 extends. Slot 40 creates two equal smaller notches 44a and 44b between feed line 26, and central patch 24. In the depicted embodiment, slot 40 has a width of 400 μm and a depth of 250 μm, while notches 44a and 44b each have width of 125 μm.

Feed line 26, in turn, includes several tapered sections 30, 32 and 34. The first tapered section 30 has a width of about 150 μm, a length, I₁ of about 950 μm (0.3λ), and an impedance of 70Ω; section 32 has a width of about 190 μm, a length of 500 μm (0.16λ) and an impedance of 60Ω; section 34 has a width of 275 μm.

The feed line sections 30, 32 and 34 of differing widths, allow feed line 26 to guide signal of a broader bandwidth than a single width feedline, allowing energy at frequencies outside the center frequency of central patch 24 to be coupled between parasitic patches 28a, 28b and central patch 24.

Conveniently, a receiver/transmitter 50 may be formed on substrate 22, along with antenna 20. A bend 36 may interconnect section 34 to a terminating section 38, also having a width of 275 μm, which in turn may interconnect antenna 20 to receiver/transmitter 50.

Antenna 20 may be etched or plated using traditional techniques. The thickness of the conductive material forming antenna 20 does not materially impact the operation/effectiveness of antenna 20. Antenna 20 may thus be etched or plated using conventional copper, aluminium, silver, gold or other conductive material.

Antenna 20 may be a transmit antenna; a receive antenna; or a combined transmit/receice antenna.

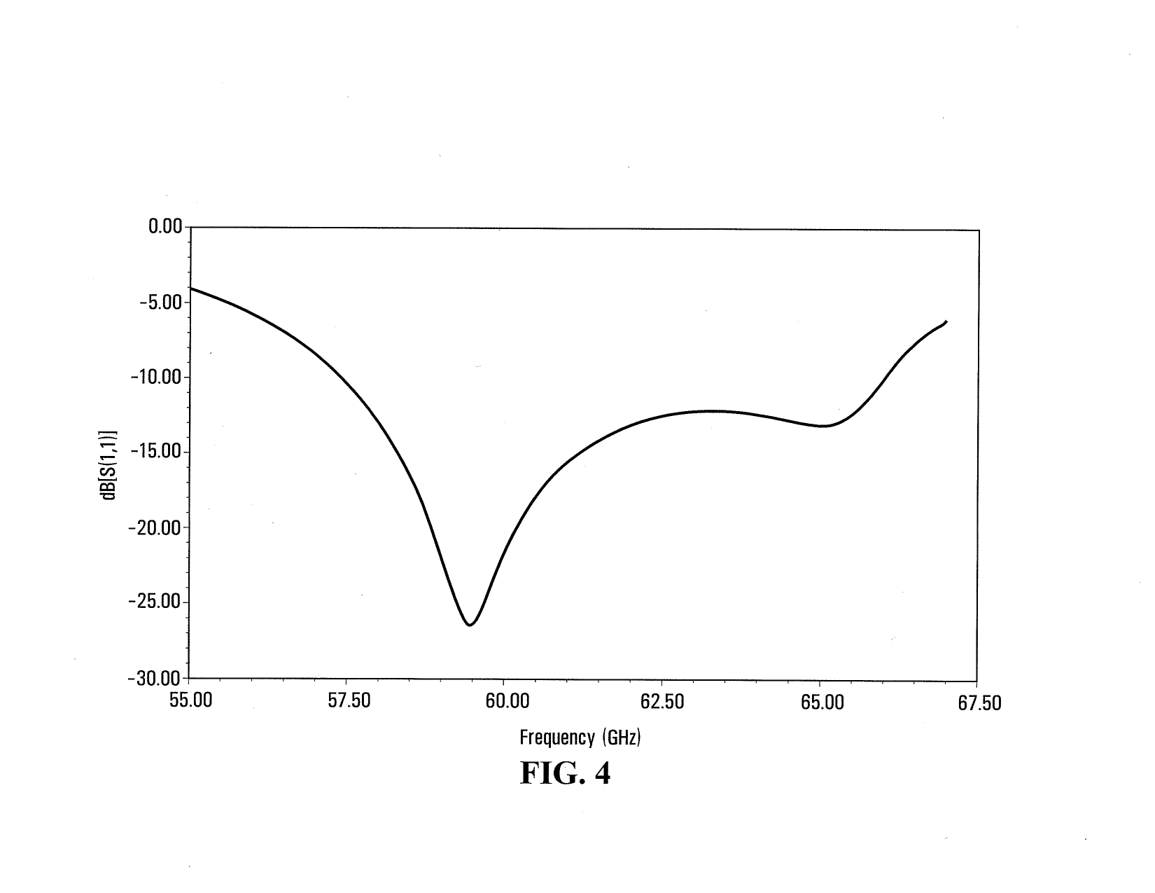

A graph illustrating (simulated) reflected power (antenna parameter S₁₁) against frequency for antenna 20 is illustrated in FIG. 4. As illustrated, reflection of antenna 20, is at a minimum (and thus maximum coupled energy) at f_{c}=57.4 MHz. Interestingly, reflection of antenna 20, is at a further local minimum (and thus maximum coupled energy) at f=66 MHz

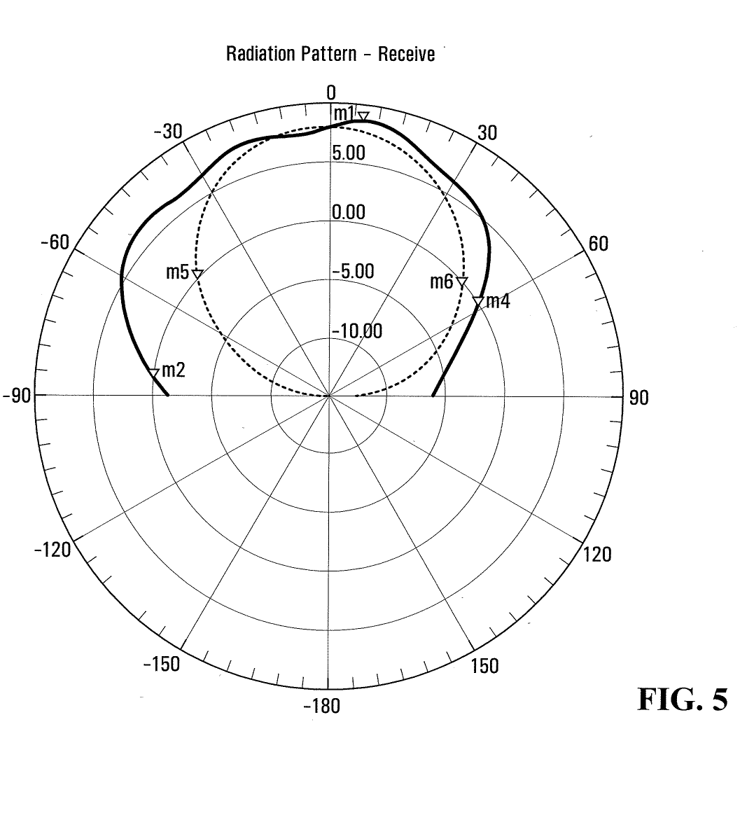

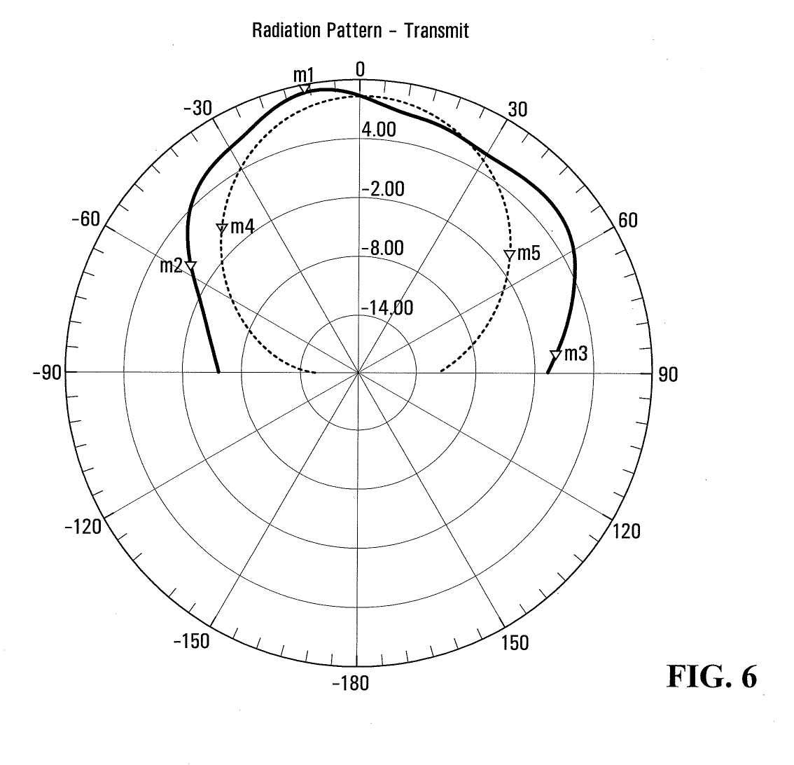

FIG. 5 is a simulated radiation pattern of a received signal received at an antenna of the form of antenna of FIG. 2, at various angels. FIG. 6 is a simulated receive radiation pattern for this antenna.

The performance of each antenna for various radio transmission channels may be further characterized by 5 parameters: Coverage, Max Gain, HPBW (deg), H0dB-Beam 1, E0dB-Beam 2 which are defined as follows.

Coverage represents the portion of the upper hemisphere where the realized gain is above 0 dBi.

Maximum Gain is the maximum realized gain at the centre frequency of the channel. Realized gain includes the antenna mismatch effects and is always smaller than (or equal to) the antenna gain.

0-dB Beamwidth is the angular separation between two points on opposite sides of the maximum of the antenna radiation pattern where the sign of the radiation gain in dB changes.

The above criteria help provide a better understanding of antenna coverage, because anywhere within the O-dB beamwidth the antenna is focusing the transmitted/received energy.

H0dB-Beam: The angular separation between two points on opposite sides of the pattern maximum in H-plane, where the sign of the radiation gain in dB changes. E0dB-Beam: The angular separation between two points on opposite sides of the pattern maximum in E-plane, where the sign of the radiation gain in dB changes.

The frequency separation between two points on opposite sides of the resonance frequency in S₁₁ or S₂₂ curves where the absolute value of the reflection coefficient is larger than or equal to 10 dB (or 8 dB).

For an example antenna of the form of antenna 20 of FIG. 2, having a center frequency of about 60.48 GHZ, characteristics of the following channels were assessed:

| | Start (GHz) | Stop (GHz) | Center (GHz) |
|---|---|---|---|
| Channel 1 | 57.24 | 59.4 | 58.32 |
| Channel 2 | 59.4 | 61.56 | 60.48 |
| Channel 3 | 61.56 | 63.72 | 62.64 |
| Channel 4 | 63.72 | 65.88 | 64.8 |

As depicted below, the RX/TX characteristics of the antenna at these channels were measured:

| | | | Max | | 0 dB- | 0 dB- |
|---|---|---|---|---|---|---|
| | | Coverage | Gain | HPBW | Beam 1 | Beam 2 |
| RX/TX | Channel | (%) | (dBi) | (deg) | (deg) | (deg) |
| RX | 1 | 60.3 | 7.2 | 76 | 98 | 132 |
| RX | 2 | 64.5 | 8.7 | 87 | 96 | 141 |
| RX | 3 | 60.1 | 8.2 | 108 | 69 | 150 |
| TX | 1 | 61.6 | 8.1 | 48 | 96 | 131 |
| TX | 2 | 65.9 | 9.1 | 75 | 98 | 143 |
| TX | 3 | 60 | 8.1 | 107 | 73 | 149 |

As can be appreciated, the above table and FIGS. 5-6 illustrate that antenna 20 provides moderate gain, with a broader coverage (i.e. beam width) than antenna 10, and a relatively broad bandwidth (about 8 MHz).

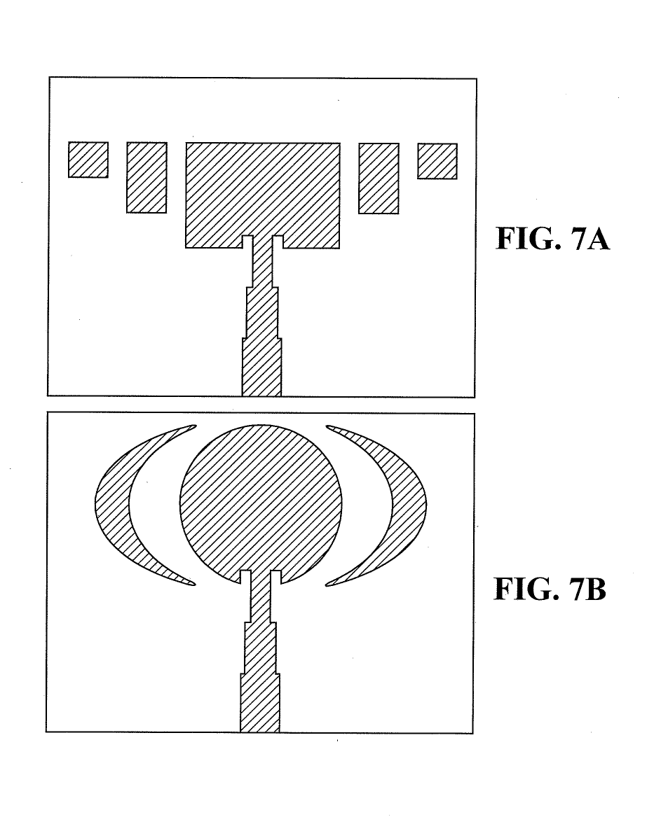

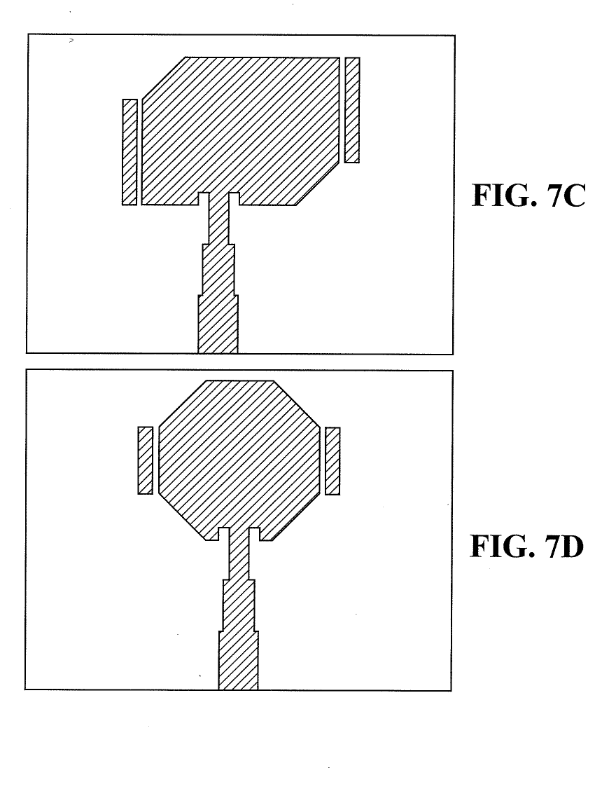

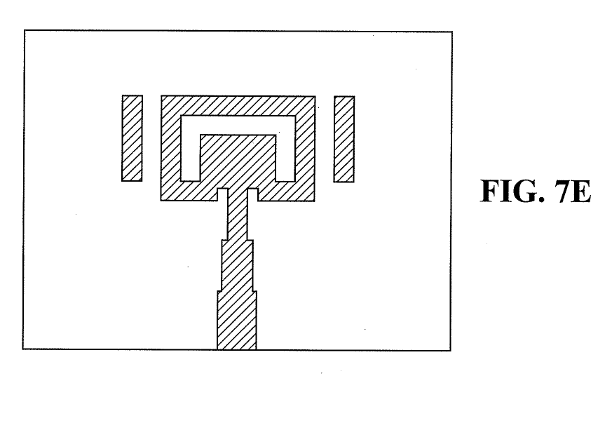

As should now be appreciated, antenna 20 is only a single possible embodiment of the present invention. Many other geometries of an antenna exemplary of the present invention are possible. For example, antennas exemplary of embodiments of the present invention as illustrated in FIGS. 7A to 7E may be formed.

As depicted in plan view in FIG. 7A, multiple parasitic patches may be formed on each side of the central patch, with several parasitic patches on each side. In the depicted embodiment of FIG. 7A two parasitic patches to be coupled to each other, and to the central patch. Again, each parasitic patch may be spaced by a distance less than λ/8, from an adjacent patch, allowing the multiple parasitic patches on each side of central patch are on either side of the central patch. More are of course possible. Parasitic patches need not be the same height, or shape or centered with the central patch Again, a feed line having sections of differing widths, that passes a broader range of frequencies from the central patch may be used.

In other geometries, as illustrated in FIG. 7B, the central patch may be circular or oval. In the even the central patch is circular/oval, parasitic patches may be crescent shaped, or may take the forme of a circular or elliptical segment (not shown).

In yet other geometries, as illustrated in FIGS. 7C and 7D, the central patch need not be square, but may instead be hexagonal (FIG. 7C) or octagonal (FIG. 7D) (with each corner of a rectangular patch eliminated). Again, the parasitic patches may be rectangular.

In yet further geometries, the central patch need not be continuous, and may have areas where the substrate is exposed, as for example in FIG. 7E.

The choice of size/geometry of central patch will be dependent on the desired center frequency of the antenna, determined as understood by those of ordinary skill. Similarly, the exact ideal shape or number of one or more parasitic patches may be experimentally determined. Again parasitic patches may be spaced suitably close to central patch (e.g. λ/8). Likewise, a suitable feedline may extend from various portions/locations of the driving/driven patch.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. An antenna comprising,
a central patch dimensioned to transmit or receive a radio signal at a center frequency f_{c} having a corresponding wavelength λ, formed on a substrate;
a feed line extending from said central patch;
at least one parasitic patch, located beside the central patch;
a ground plane formed on an opposite side of said substrate;
said parasitic patch, electrically disconnected from said central patch, and located a lateral distance d≦λ/8 from said central patch.

2. The antenna of claim 1, comprising first and second parasitic patches.

3. The antenna of claim 2, wherein each of said parasitic patches has a vertical center, aligned approximately with the vertical center of said central patch.

4. The antenna of claim 1, wherein said central patch is generally rectangular.

5. The antenna of claim 1, wherein said central patch has six sides.

6. The antenna of claim 1, wherein said central patch has eight sides.

7. The antenna of claim 2, wherein said central patch is generally circular.

8. The antenna of claim 7, wherein each of said first and second parasite patches are generally crescent shaped.

9. The antenna of claim 2, wherein said first and second parasitic patches are generally rectangular.

10. The antenna of claim 2, wherein each of said central patch and said first and second parasitic patches have the same height.

11. The antenna of claim 2, wherein said central patch comprises a slot, receiving said feed line.

12. The antenna of claim 1, wherein said feed line has two or more portions of differing width.

13. The antenna of claim 1, wherein said central patch has an area less than λ_{f}²/4.

14. The antenna of claim 11, wherein said slot creates two notches between said feed line and said central patch.

15. The antenna of claim 1, tuned for a frequency of about 60 GHz.

16. The antenna of claim 1, wherein said central patch has dimensions equal to about 1700×1240 μm and each said parasitic patches has dimensions equal to about 420×1240 μm.

17. The antenna of claim 10, wherein space d between central patch and parasitic patches is about 280 μm.

18. A microstrip antenna comprising at least one parasitic patch, located beside a central patch, said parasitic patch electrically disconnected from said central patch, but inductively coupled thereto aid in transferring energy to and from said central patch.

19. A method of operating an antenna to radiate an electromagnetic field, said method comprising:
providing a central patch dimensioned to emit a radio signal at a center frequency f_{c} having a corresponding wavelength λ, formed on one side of a substrate having aground plane formed on an opposite side thereof;
providing at least one parasitic patch, located beside the central patch;
driving said central patch by current from a transmitter and thereby inducing current to said parasitic patch that contributes constructively in radiating said electromagnetic field.
